(19) United States
(12) Patent Application Publication
(10) Pub. No.: US 2008/0320298 A1
(43) Pub. Date: Dec. 25, 2008

(54) System and Method for Protecting Electronic Devices

(75) Inventor: Andrianus Johannes Stephanus De Vaan, 'S-Hertogenbosch (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 12/097,637

(22) PCT Filed: Dec. 13, 2006
(86) PCT No.: PCT/IB06/54824

§ 371 Date: Jun. 16, 2008

Related U.S. Application Data
(60) Provisional application No. 60/752,079, filed on Dec. 20, 2005.
(60) Provisional application No. 60/868,762, filed on Dec. 6, 2006.

(51) Int. Cl. G06F 21/00

(52) U.S. Cl. 713/155

(57) ABSTRACT

An electronic safe includes apparatus ID codes of various electronic devices as well as security keys associated with the apparatus ID codes. In order for an electronic device to be operated, it must first make connection with the electronic safe in order to verify the security key. Once the security key is received and verified, the electronic device is enabled to perform its function. However, if the security key is not received or not verified, the electronic device is disabled until such time as the security key is received and verified. This would effectively render stolen electronic devices unusable and worthless.

The subject invention relates to a system and method for protecting electronic devices.

Electronic devices are becoming smaller and lighter, and as such, are easier to steal. For this reason, theft protection is becoming more and more a requirement, and is therefore becoming an important buying criteria.

A number of theft prevention methods exist, such as requiring ID keys that need to be entered before the set can be used. However, these methods are inconvenient and user unfriendly in that they require the user to remember the various ID keys for use with each electronic device. Further, users are known to be lax in protecting their ID keys, and if learned by others, the security of the electronic devices is compromised.

It is an object of the invention to alleviate the short-comings of the prior art methods. This object is achieved in a system for providing security for an electronic apparatus, said system comprising an electronic safe having a processor, a memory coupled to the processor for storing security keys associated with various electronic apparatus, and an interface coupled to the processor for receiving and transmitting information to and from the electronic safe a network for connecting to the interface in the electronic safe, and at least one electronic apparatus having a processor, a memory coupled to the processor for storing a security key corresponding to one of said security keys stored in the memory in the electronic safe, and an interface for connecting the electronic apparatus to the network, wherein said processor requests and verifies a security key received from the electronic safe, and if said security key is verified, said processor enables the electronic apparatus, and if said security key is not verified, said processor disables the electronic apparatus.

As such, it is necessary for the electronic device to verify its own authentication prior to the user being able to use the electronic device. Hence, the user of the system does not need to remember the enabling keys for each of the electronic devices. Rather, these security keys are stored in the electronic safe, the accuracy of which being verified prior to the electronic device being enabled for use. If the electronic device is thereafter stolen, the new user will not be able to connect the electronic device to the electronic safe in order to obtain the security key, thereby rendering the electronic device useless.

With the above and additional objects and advantages in mind as will hereinafter appear, the invention will be described with reference to the accompanying drawings, in which:

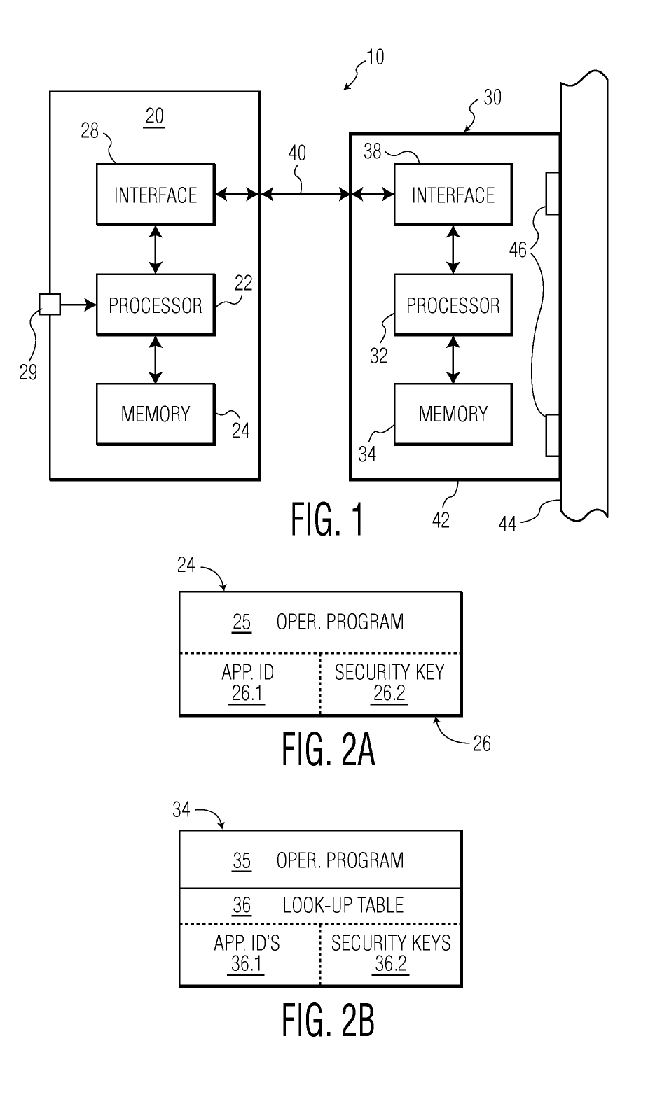

FIG. 1 is a block schematic diagram of the system of the subject invention;

FIG. 2A shows a block diagram of the memory in an electronic device, while

FIG. 2B shows a block diagram of the memory in the electronic safe; and

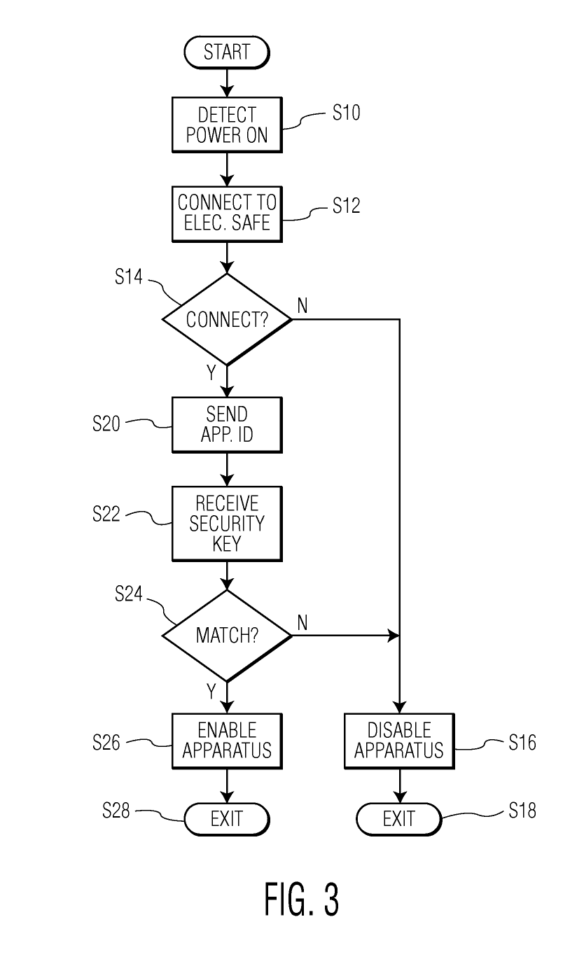

FIG. 3 shows a flowchart of the processing in the electronic device.

As shown in FIG. 1, the system 10 of the subject invention includes at least one electronic device 20, an electronic safe 30, and an interconnecting network 40. The electronic device 20, which may be a television receiver, a VCR, a DVD recorder/player, a portable PDA, etc., includes a processor 22, a memory 24 and an interface 28. As shown in FIG. 2A, the memory 24 includes a portion 25 for containing a system program for controlling the processor 22 and a portion 26 for containing an apparatus ID 26.1 for uniquely identifying the electronic device 20 and a security key 26.2. The interface 28 connects the electronic device 20 to the interconnecting network 40.

The electronic safe 30 includes a processor 32, a memory 34 and an interface 38. As shown in FIG. 2B, the memory 34 includes a portion 35 for containing a system program for controlling the processor 32 and a portion 36 forming a look-up table containing the apparatus ID's 36.1 and their associated security keys 36.2. The interface 38 connects the electronic safe 30 to the interconnecting network 40.

The interconnecting network 40 may be of any known design. In particular, the interconnecting network 40 may be a wired network interconnecting the electronic safe 30 to each of the electronic devices 20. Alternatively, the interconnecting network 40 may be wireless.

FIG. 3 shows a flowchart illustrating how the system of the subject invention operates. In particular, upon the user depressing the ON/OFF switch 29 of the electronic device 20, the processor 22, at step S10, detects this operation and, at step S12, attempts to connect to the electronic safe 30 via the interconnecting network 40. At step S14, it is determined whether such a connection is established. If not, at step S16, the processor 22 disables the electronic device 20 and exits the flowchart at step S18. If at step S14, the network connection is established, at step S20, the processor 22 sends the apparatus ID 26.1 to the electronic safe 30 and at step S22, the processor 22 awaits receipt of the corresponding security key 36.2. At step S24, the processor compares the received security key 36.2 with the security key 26.2 stored in the electronic device 20. If there is not a match, the system reverts to step S16 and the processor 22 disables the electronic device 20 and exits the flowchart at step S18. If, on the other hand, at step S24, there is a match, at step S26, the processor 22 enables the electronic device 20 and exits the flowchart at S28.

As shown in FIG. 1, the electronic safe 30 is contained in a physically secure housing 42 which is attached to, for example, a wall 44 of the house of the user using fasteners 46.

It should be understood that the electronic device 20 may be a stationary device, such as a television receiver, CD recorder/player, DVD recorder player, etc. Alternatively, the electronic device 20 may be a portable device, such as a PDA, a mobile telephone, a digital music player, etc. So long as the electronic device 20 is left on after achieving a connection with the electronic safe 30 after turn-on, the electronic device 20 is enabled. However, in the case of a portable device, once the portable device is turned off, the user needs to re-establish a connection with the electronic safe 30 in order to reactivate the portable device.

In addition to checking the security key on turn-on of the electronic device 20, the processor 22 may initiate a check of the security key with the electronic safe 30 at regular intervals during the operation of the electronic device 20, e.g., every hour.

While the electronic safe 30 has be shown and described as a separate item, alternatively, the electronic safe 30 may be installed within one of the connected electronic devices 20, for example, the electronic safe 30 may be included in, for example, a large-screen television receiver.

Although this invention has been described with reference to particular embodiments, it will be appreciated that many variations will be resorted to without departing from the spirit and scope of this invention as set forth in the appended claims. The specification and drawings are accordingly to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts is intended to be required unless specifically indicated.

1. A system for providing security for an electronic apparatus, said system comprising:
an electronic safe having a processor, a memory coupled to the processor for storing security keys associated with various electronic apparatus, and an interface coupled to the processor for receiving and transmitting information to and from the electronic safe;
a network for connecting to the interface in the electronic safe; and
at least one electronic apparatus having a processor, a memory coupled to the processor for storing a security key corresponding to one of said security keys stored in the memory in the electronic safe, and an interface for connecting the electronic apparatus to the network, wherein said processor requests and verifies a security key received from the electronic safe, and if said security key is verified, said processor enables the electronic apparatus, and if said security key is not verified, said processor disables the electronic apparatus.

2. The system as claimed in claim 1, wherein the network is a wired network for connecting the interface in the electronic safe with the interface in the at least one electronic apparatus.

3. The system as claimed in claim 1, wherein the network is a wireless network for connecting the interface in the electronic safe with the interface in the at least one electronic apparatus.

4. The system as claimed in claim 1, wherein the electronic safe is arranged in a physically secure housing, said housing being anchored in a building.

5. An electronic safe comprising:
a processor;
memory coupled to the processor for storing an operating program for the processor, and for storing security keys associated with various electronic apparatus whose operation is to be secured by said electronic safe; and
an interface coupled to the processor for connecting the electronic safe to a network, said interface receiving and transmitting information to and from the electronic safe, from and to said various electronic apparatus,
wherein said operating program, in response to a request from at least one of said various electronic apparatus, causes said processor to send the associated security key to the requesting at least one of said various electronic apparatus.

6. The electronic safe as claimed in claim 5, wherein said electronic safe further comprises:
a physically securing housed in which said processor, said memory and said interface are located; and
means for anchoring said physically securing housing in a building.

7. An electronic apparatus for use with an electronic safe, said electronic apparatus comprising:
a processor;
memory coupled to the processor for storing an operating program for the processor, and for storing a security key; and
an interface coupled to the processor for connecting the electronic apparatus to a network, said interface receiving and transmitting information from and to the electronic safe, wherein said operating program, in response to an event, causes the processor to request a security key from said electronic safe, to compare the received security key to the security key stored in the memory, to allow continued operation of the electronic apparatus if the received security key matches the stored security key, and to stop operation of the electronic apparatus if no security key is received or if the received security key does not match the stored security key.

8. The electronic apparatus as claimed in claim 7, wherein said event is a turning on of said electronic apparatus.

9. The electronic apparatus as claimed in claim 7, wherein said event is the elapsing of a predetermined time interval during operation of the electronic apparatus.

10. A method of protecting electronic apparatus, comprising the steps of:
assigning to and storing in each electronic apparatus a unique security key;
storing said unique security keys in a remotely located electronic safe;
causing said electronic apparatus to request the security key from the electronic safe upon the occurrence of an event in the operation of said electronic apparatus;
allowing continued operation of said electronic apparatus if the received security key matches the security key stored in the electronic apparatus; and
discontinuing operation of said electronic apparatus if no security key is received or if the received security key does not match the security key stored in the electronic apparatus.

11. The method as claimed in claim 10, wherein said event is the turning on of said electronic apparatus.

12. The method as claimed in claim 10, wherein said event is the elapsing of a predetermined time interval during operation of the electronic apparatus.
